(19) United States
(12) Patent Application Publication
(10) Pub. No.: US 2007/0023940 A1
(43) Pub. Date: Feb. 1, 2007

(54) Environmentally controlled enclosure for musical instruments

(76) Inventor: Charles P. Siess III, Conroe, TX (US)

Correspondence Address: Mark R. Wisner;Wisner & Associates, Suite 400, 1177 West Loop South, Houston, TX, 77027-9012, US

(21) Appl. No.: 11/450,511

(22) Filed: Jun. 10, 2006

Related U.S. Application Data
(60) Provisional application No. 60/689,829, filed on Jun. 13, 2005.

(51) Int. Cl. A24F 25/00; F02M 17/28

(52) U.S. Cl. 261/131; 312/31

(57) ABSTRACT

An environmentally controlled enclosure for a musical instrument that continuously monitors and increases and decreases humidity levels within the enclosure as needed to maintain a humidity level selected for the purpose of preserving the musical instrument stored therein. The enclosure is particularly useful in protecting and preserving musical instruments having one or more component parts made of wood, which is particularly sensitive to abrupt changes in humidity and to exposure to humidity extremes. The enclosure is provided with a sensor for monitoring humidity levels that is operably connected to a control unit for controlling the equipment for increasing and decreasing the humidity within the enclosure.

### BACKGROUND OF THE INVENTION

The present invention relates to an environmentally controlled enclosure for storage and protection of musical instruments. In more detail, the present invention relates to an enclosure in which a musical instrument is stored in which humidity and temperature are controlled for protection and preservation of the instrument.

Rapid changes in humidity, especially changes in which humidity increases to above about 70% or below about 40%, can cause damage to the wood that comprises both acoustic and electric musical instruments. Similarly, long periods of exposure to humidity levels above about 70% and/or below about 40% can damage such instruments. Stringed instruments having wooden bodies, bridges, and necks are particularly susceptible to damage from humidity changes and/or extremes. The present invention addresses this problem by providing an enclosure in which humidity levels are maintained at levels optimized for the preservation of the instrument.

It is, therefore, an object of the present invention to provide an environmentally controlled enclosure in which humidity levels are maintained at levels optimized for the preservation of a musical instrument stored in the enclosure.

Another object of the present invention is to provide an enclosure for preservation of a musical instrument in which humidity levels are continuously monitored and adjusted so as to maintain a humidity level selected so as to preserve the instrument stored therein.

Yet another object of the present invention is to provide a method for preserving a musical instrument comprising the steps of placing the instrument in an enclosure that is relatively impermeable to water vapor and selecting a humidity level to be maintained in the enclosure. The humidity level in the enclosure is then determined and, if the humidity level is lower than the selected humidity level, a fan is switched on to move air over a water reservoir to increase the humidity level in the enclosure. Alternatively, if the

Other objects, and the many advantages of the present invention, will be made clear to those skilled in the art in the following detailed description of several preferred embodiments of the present invention and the drawings appended hereto. Those skilled in the art will recognize, however, that the embodiments of the invention described herein are only examples provided for the purpose of describing the making and using of the present invention and that they are not the only embodiments of environmentally controlled enclosures for preservation of musical instruments that are constructed in accordance with the teachings of the present invention.

### SUMMARY OF THE INVENTION

The present invention addresses the above-described problem by providing an enclosure comprised of a relatively vapor impermeable material having a door that is opened or closed for inserting or removing a musical instrument from the enclosure that, when closed, effectively provides an environment in which temperature and humidity can be controlled. A control unit is provided including means for selecting a temperature and humidity level inside the enclosure at desired levels. A water reservoir is provided for increasing humidity inside the enclosure as needed to maintain the selected humidity level and a desiccant is provided for decreasing humidity inside the enclosure as needed to maintain the selected humidity level. A fan or blower is provided for circulating air inside the enclosure over either the water reservoir or the desiccant to increase or decrease humidity. In a particularly preferred embodiment, a heating element is also provided for decreasing humidity levels in the enclosure.

Also provided is a method of preserving a musical instrument comprising the steps of placing an instrument in an enclosure that is relatively impermeable to water vapor and selecting a humidity level to be maintained in the enclosure. The humidity level in the enclosure is then determined and, if the humidity level in the enclosure is lower than the selected humidity level, a fan is switched on to move air over a water reservoir to increase the humidity level in the enclosure. Alternatively, if the humidity level in the enclosure is below a selected humidity level, the fan moves air over a desiccant to decrease the humidity level in the enclosure.

### BRIEF DESCRIPTION OF THE DRAWINGS

Referring now to the figures, FIG. 1 shows a perspective view of one embodiment of an environmentally controlled enclosure for a musical instrument constructed in accordance with the teachings of the present invention.

FIG. 2 is a schematic diagram showing the internal layout of the environmentally controlled enclosure of FIG. 1.

FIG. 3 is a partially schematic diagram of a portion of the inside of the environmentally controlled enclosure of FIG. 1 showing the water reservoir and desiccant for increasing and decreasing the humidity level in the enclosure, respectively.

### DETAILED DESCRIPTION OF THE PREFERRED EMBODIMENT(S)

Referring now to the figures, FIG. 1 shows a perspective view of an environmentally controlled enclosure, indicated generally at reference numeral 10, for a musical instrument that is constructed in accordance with the teachings of the present invention. In the embodiment shown, the enclosure 10 is comprised of several frame members 12 to which panels 14 comprised of acrylic, glass, Plexiglas, Lexan, or other durable transparent material are fitted to completely enclose the frame members 12. A door is provided in the form of a panel 16 mounted to one of the frame members 12 on hinges 18 that is opened or closed for inserting or removing a musical instrument from enclosure 10. Although the particular enclosure 10 shown in FIG. 1 is provided with transparent panels 14 and a transparent door 16 for the purpose of displaying the instrument 20 enclosed therein, those skilled in the art who have the benefit of this disclosure will recognize that the panels 14 and door 16 may also be comprised of opaque materials. For instance, plastic or fiberglass panels may be provided or, for security, even metal panels such as stainless steel may be provided for protecting and preserving valuable musical instruments such as violins from Cremona, Italy or fine guitars such as those manufactured by the C.F. Martin Company, Nazareth, Pa.

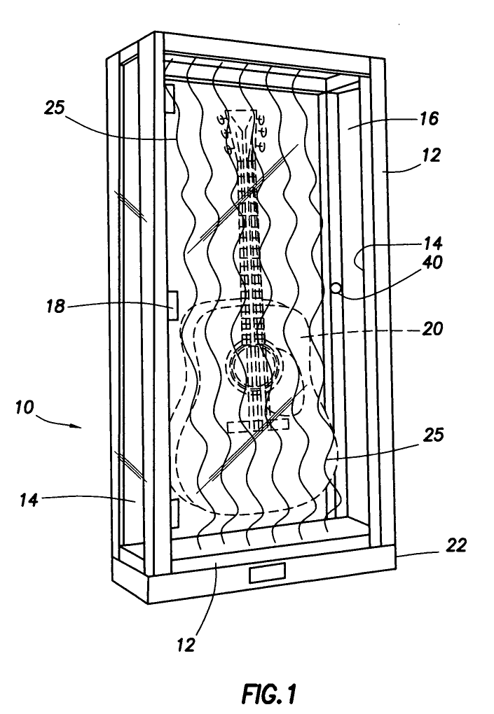

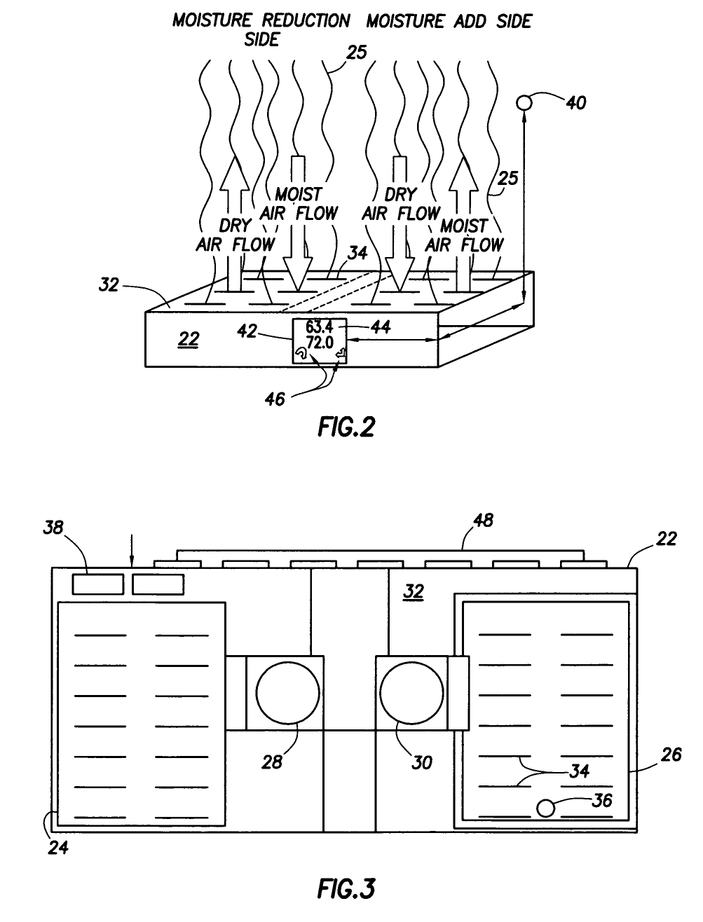

Referring now also to FIGS. 2 and 3, the enclosure 10 of the present invention is provided with a base 22 having two containers 24, 26 residing therein, one container 24 being provided for the purpose of containing a desiccant (not shown) such as silica and the second container 26 being provided for the purpose of acting as a water reservoir. Blower fans 28, 30 are located near each of the containers 24, 26 and the output from blower fans 28, 30 is directed over the respective container 24, 26 to provide effective air movement of dry and moist air, respectively, as needed for the purpose of maintaining humidity in the enclosure at a selected level as described in more detail below. A removable bulkhead 32 is fitted to interior of the enclosure 10 to separate the containers 24, 26 from the main portion of the enclosure, thereby protecting the instrument 20 stored therein from contact with the desiccant or the water in the respective containers 24, 26 while still allowing access to the container 24, 26 and fans 28, 30 when necessary, for instance, for service or replacement. A water fill port 36 is provided in base 22 that communicates with the water reservoir/container 26 for replenishing the water therein; the location of the water fill port 36 in base 22 allows the water in container 26 to be replenished without opening the door panel 16, thereby maintaining the humidity within enclosure 10. As best shown in FIG. 2, sets of slots 34 are provided in bulkhead 32 to allow unrestricted passage of dry air or moist air from the respective fans 28, 30 located near the respective desiccant container 24 or water container 26 to the interior of enclosure 10 as represented by the wavy lines 25 shown in FIGS. 1 and 2.

Also located in the base 22 are one or more batteries, preferably rechargeable batteries 38, for the purpose of providing electrical power to the blower fans 28, 30 and the temperature and humidity sensors, controls, and heating element described below in the event of power failure. For purposes of clarity, and because it is known in the art, the wiring to and from batteries 38, fans 28, 30, humidity and temperature sensors, and controls (all described below) are not shown in the figures. In the particular embodiment shown in the figures in which enclosure 10 stands upright on base 22, the batteries 38 also provide enough weight in the base 22 to stabilize the enclosure 10 in the upright position, but those skilled in the art who have the benefit of this disclosure will recognize that the enclosure 10 need not stand upright such that this function of the batteries 38 is merely an advantage of the construction of the particular embodiment shown in the figures and not necessarily considered an essential element of the present invention. It will also be noted that, like the containers 24, 26 and fans 28, 30, batteries 38 are located below bulkhead 32 for the protecting the instrument 20 contained in enclosure 10. Although not shown, it will be recognized by those skilled in the art that the batteries are preferably located in base 22 and either affixed thereto by a suitable bracket or rest therein in a compartment sized so as to retain the batteries 38 against unrestricted movement within base 22.

Referring again to FIGS. 1 and 2, a sensor probe 40 is provided within the enclosure 10 which preferably includes sensors for temperature and humidity, but those skilled in the art will recognize that it is not essential that a temperature sensor be included within probe 40. Sensor probe 40 is connected by suitable wiring (not shown) to a control unit 42 in base 22 which includes a microprocessor and suitable display 44, the microprocessor being programmed to continuously poll the output from sensor probe 40, display the current humidity and temperature in enclosure 10 on display 44, and switch the fans 28, 30 on and off as may be needed to maintain a selected humidity level in enclosure 10. In a particularly preferred embodiment, display 44 includes membrane switches 46 for increasing and decreasing humidity to a selected humidity level and such suitable other controls or switches as may be useful in maintaining a selected humidity and temperature level in enclosure 10, but those skilled in the art will recognize from this disclosure that other switches, dials, and the like are also adaptable for this purpose such that the present invention is not limited to the particular embodiment shown in the figures. The microprocessor contained within control unit 42 also preferably includes a switch for switching a resistive heating element (not shown) located in the base 22 on or off as needed to facilitate temperature and/or humidity control.

In a particularly preferred embodiment, the enclosure 10 of the present invention is provided with a terminal strip 48 including a variety of connectors for input and output to the control unit 42. The terminal strip preferably includes connectors for AC and/or DC power, high speed internet, USB, phone, security system, and an auxiliary input. Such connectors allow remote monitoring and control of temperature and humidity within enclosure 10 via computer, computer network, or the Internet. The microprocessor within control unit 42 is preferably provided with its own IP address to facilitate this function; remote ethernet connectivity may also be provided within the microprocessor, all as known in the applicable art. A number of additional functions that may be included are alarm contacts, motion sensors, and Webcams for security, phone line interface with dialer with security call alert capability, VOIP and/or self-contained “bag phone” dial out unit interface, and remote tracking of a sensor applied to the instrument by suitable wireless, radio, or other proximity sensors or tracking system hardware and software as known in the art.

Although described herein in terms of the self-contained enclosure 10, it will be recognized by those skilled in the art that the present invention may also take the form of a box for attaching to a separate enclosure that includes the component parts described in this specification for increasing and decreasing the humidity within the separate enclosure. For instance, guitar display cases are currently available from such vendors as the aforementioned C.F. Martin Company, and the apparatus of the present invention may be constituted as an add-on for such display cases, fitted to the particular size and shape of the display case, for controlling the humidity levels within that separate enclosure.

Those skilled in the art who have the benefit of this disclosure will recognize that certain changes can be made to the component parts of the apparatus of the present invention without changing the manner in which those parts function to achieve their intended result. By way of example, it is possible that the humidity within enclosure 10 may be decreased to a selected humidity level without the use of the desiccant and that a resistive or other type of heater is all that is required to dry the atmosphere within enclosure 10; similarly, there are other ways to increase the humidity in a confined space other than by the use of a water reservoir as described herein. For these reasons, reference is made in this specification to means for decreasing humidity and means for increasing humidity within the enclosure 10. All such changes, and others which will be clear to those skilled in the art from this description of the preferred embodiments of the invention, are intended to fall within the scope of the following, non-limiting claims.

What is claimed is:

1. An environmentally controlled enclosure for a musical instrument comprising:
frame members and panels forming an enclosure;
a humidity sensor located within said enclosure;
means for increasing and means for decreasing the humidity within said enclosure;
a sensor for sensing the humidity within said enclosure;
a control unit for selecting a desired humidity level within said enclosure operable to selectively switch said humidity increasing and said humidity decreasing means on and off as needed to maintain the selected humidity level within said enclosure.

2. The musical instrument enclosure of claim 1 wherein said enclosure is also provided with means for increasing the temperature within said enclosure, said sensor also senses temperature, and said control unit is provided with means for switching said temperature increasing means on and off.

3. The musical instrument enclosure of claim 1 wherein said control unit displays the current humidity within said enclosure and the selected humidity level within said enclosure.

4. The musical instrument enclosure of claim 1 wherein said humidity increasing means comprises a water reservoir and a fan for blowing air over said water reservoir.

5. The musical instrument enclosure of claim 1 additionally comprising means for remote monitoring and control of said enclosure.
